(19) United States
(12) Patent Application Publication
(10) Pub. No.: US 2026/0100774 A1
(43) Pub. Date: Apr. 9, 2026

(54) MULTI-FREQUENCY, MULTI-THREADING RECEIVER

(71) Applicants: Tractian Technologies Inc, Atlanta, GA (US); Tractian Limited, Sao Paulo (BR)

(72) Inventors: Andrei Alves Cardoso, Sao Paulo (BR); Igor Vinicius Alvarenga Marinelli, Atlanta, GA (US); Pedro Calori Badini, Sao Paulo (BR)

(21) Appl. No.: 19/354,590

(22) Filed: Oct. 9, 2025

Related U.S. Application Data
(60) Provisional application No. 63/705,453, filed on Oct. 9, 2024.

(51) Int. Cl. H04B 17/391; H04W 24/10; H04W 72/30

(52) U.S. Cl. CPC H04B 17/3912; H04W 24/10; H04W 72/30

(57) ABSTRACT

An example operation includes receiving, via a receiver, sensor data from a number of sensors at a number of times, queuing, via the receiver, the sensor data based on the number of times the sensor data was received, multiplexing, via the receiver, the sensor data, and forwarding, via the receiver, the multiplexed sensor data to a cloud network including a number of sensor threads storing sensor data for each of the respective sensors.

### CROSS-REFERENCE TO RELATED APPLICATIONS

This application claims the benefit of priority to U.S. Provisional Application No. 63/705,453, filed on Oct. 9, 2024, which is hereby incorporated by reference in its entirety.

### FIELD OF INVENTION

Various embodiments relate generally to a multi-frequency and multi-threading receiver for multiplexing sensor data.

### SUMMARY

The appended claims may serve as a summary of this application. Various embodiments described herein provide improvements to conventional receivers used to capture sensor data from various sensors. The need for sensors and the management of sensor data continues to grow. Sensors are used to capture various information depending on the type of sensor and the environment where the sensors are deployed. A receiver can be installed to receive sensor data from multiple sensors and forward the data to a cloud network where interested third parties can access the sensor data.

The connection procedure between a sensor and a receiver may begin by the sensor transmitting a broadcast packet that should be responded to by the receiver with a confirmation that the receiver is available for communication. After a sensor transmits a broadcast message, the sensor may wait a period of time, such as 100 ms or another time interval considered relevant to those skilled in the art, and listen for a response from any nearby receivers. The sensor may have its own flash memory and may be able to store various sensor readings in a queue to transfer to a receiver. The sensor may also have a list of receivers which are available to communicate with the sensor based on answer messages received by various sensors. The list may include additional information, such as a received signal strength indicator (RSSI) for each receiver, which can be used as the basis for selecting a receiver to communicate with during sensor data exchange operations. The higher/larger or stronger the RSSI value identified for a particular receiver, the more likely that receiver will be selected as a candidate receiver for a particular sensor when compared to other RSSI values of other receivers.

A receiver or smart receiver may support various radio frequency (RF) channels, such as 915, 917, 919, 921, 923 MHz. The RF circuitry inside a receiver may be limited to the use of one channel at a time or one specific frequency. The sensor may need a specific element to identify the channel available by the receiver and a specific gateway may be needed to allocate a different channel. When using multiple channels, a sensor may repeat the discovery process for each channel and a channel field may also be identified and stored in the list of information maintained by the sensor and associated with the receiver(s).

In various embodiments, when a receiver is powered on, a search process may be performed to identify other receivers. This process may include transmitting a broadcast message or beacon and waiting for responses. The responses may be received on any one of the available channels supported by the receiver. A list may be maintained by the receiver to identify which channels are receiving responses along with certain receiver information (e.g., identification values, RSSI values, etc.). A receiver can then evaluate the channel with the least allocated receivers using that channel and allocate that channel as the channel to be used for a period of time. This process may be performed by a radio tuning procedure. The channel allocation process may cause the various receivers to use different channels and spread their communications across all available RF channels to optimize the amount of usage for related communication efforts.

The amount of battery power for each sensor may be limited, in order to achieve a longer battery life, smart receivers may be used, which tune their frequency and band usage in an optimal manner to accommodate the sensors. The receivers may be responsible for forwarding received sensor data to the cloud via an Internet connection. Available sensors can optimally share sensor data with a local receiver on an available channel with a most optimal (highest, largest, etc.) RSSI value and an available channel. The optimization will decrease the amount of power usage from sensors which would normally send data repeatedly on non-optimized channels to remote receivers with sub-optimal power characteristics. The optimization may also reduce the amount of receivers needed to support the various sensors. Additionally, multiplexing the sensor data from each sensor may provide an efficient and organized way to store sensor data in unique sensor profiles (threads) managed by the cloud network.

### BRIEF DESCRIPTION OF THE DRAWINGS

The present invention relates generally to optimal receiver use and communications with sensors.

The present disclosure will become better understood from the detailed description and the drawings, wherein:

FIG. 1 illustrates an example network of sensors communicating with a receiver during one or more communication sessions according to example embodiments;

FIG. 2 illustrates an example sensor data multiplexing operation according to example embodiments;

FIG. 3 illustrates an example process of a receiver establishing a connection with one or more sensors according to example embodiments;

FIG. 4A illustrates an example process of the sensor identifying and selecting available receivers according to example embodiments;

FIG. 4B illustrates an example process of the receiver managing sensor data according to example embodiments; and

FIG. 5 is a diagram illustrating an exemplary computer that may perform processing in some embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, computer readable storage medium and system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer readable media or a non-transitory computer readable storage medium.

The instant features, structures, or characteristics described in this specification may be combined in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one example. Thus, appearances of the phrases “example embodiments”, “in some embodiments”, “in other embodiments,” or other similar language, throughout this specification can all refer to the same embodiment. Thus, these embodiments may work in conjunction with any of the other embodiments, may not be functionally separate, and the described features, structures, or characteristics may be combined in any suitable manner in one or more embodiments.

Example embodiments provide methods, systems, hardware components, non-transitory computer readable media, devices, and/or networks, which provide receiver management of sensor data for various sensors. A single RF receiver may support a number of sensors by receiving the sensor data captured by the sensors and forwarding the data to a remote data source in the cloud. A single receiver may be receiving sensor data from various sensors (S1, S2 . . . . SN). Sensors are generally placed at various locations when used to monitor an asset location. A sensor may monitor changes to weather, light, sound, movement, etc. A sensor may have a battery with a limited amount of power available to maintain operation of the sensor. One way to limit overuse of a sensor battery may be to have the sensor data forwarded and received efficiently to avoid resending sensor data repeatedly and/or sending sensor data to a closer receiver or one that maintains a higher RSSI value than other sensors to avoid using additional power to transmit the sensor data wirelessly in an ongoing basis.

To support many sensors while receiving their respective sensor data via a single receiver, a multiplexing (MUX) process may be employed to maintain a queue of sensor data that is distributed to the proper cloud storage locations assigned to each sensor. When the sensor(s) communicates with a particular receiver, the sensors may listen for radio signals intended for that particular receiver and wait for the signals to stop prior to transmitting data intended for the receiver. The receiver may take turns communicating with many different sensors. In one example, the receiver sends a message to one sensor, then another sensor, and so on, one at a time ((T1, S1), (T2, S2), etc.), so that each sensor may have a turn communicating with the receiver. With a single channel being operational at one particular time on one particular receiver, the amount of communication bandwidth is limited.

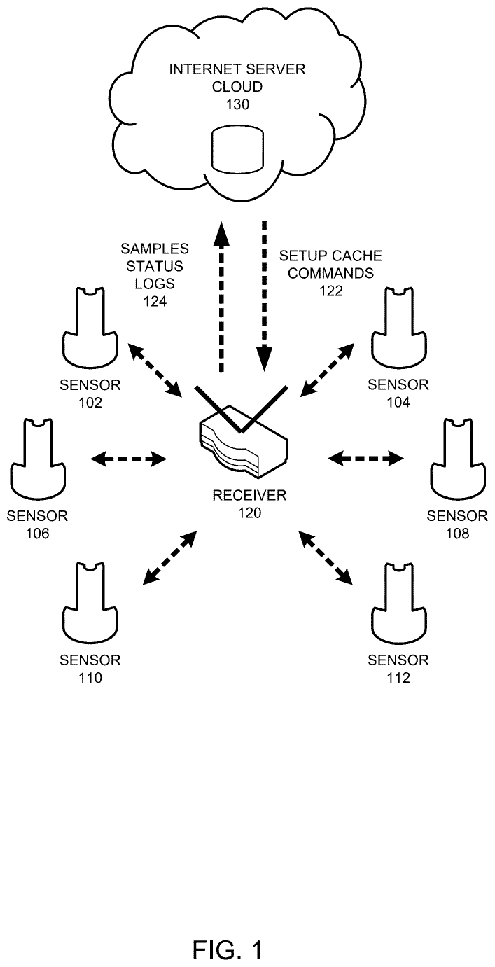

FIG. 1 illustrates an example network of sensors communicating with a receiver during one or more communication sessions according to example embodiments. Referring to FIG. 1, a single receiver is illustrated 120 as having communications with six different sensors 102, 104, 106, 108, 110 and 112. As information is provided to the radio receiver 120, the sensor sample data, status information and other log information 124 may be sent to the cloud for storage 130 in a corresponding sensor thread dedicated to each sensor. An interested party may pool together all the sensor threads to deduce certain information related to the environment of a particular asset being tracked by the sensor data. Certain commands 122 may be sent from the cloud 130 to the receiver 120 to distribute to the sensors depending on the settings desired by the management entity. For example, a sensor may be instructed to perform sensor captures every (1) second or every 10 seconds or once a minute, etc. If each sensor is sending data to the receiver once per second, the receiver 120 may queue the data in time slots and multiplex the data as it prepares to send the data to the cloud 130 based on a particular interval. One message may be sent every second which contains six samples of data as one per sensor depending on the communication strategy employed.

A single band, such as 915 MHz can be used to transfer all the information over a wireless medium by using time division or time slots for each portion of data received and sent. Each sensor's data may have a dedicated time slot when it is sent to the receiver and from the receiver to the cloud 130. This time slot approach also limits the amount of time a sensor is attempting to communicate with the receiver 120, instead of constantly transmitting data to the receiver 120, the sensors are only transmitting data for a short period of time until it becomes the particular sensor's turn to again communicate with the receiver.

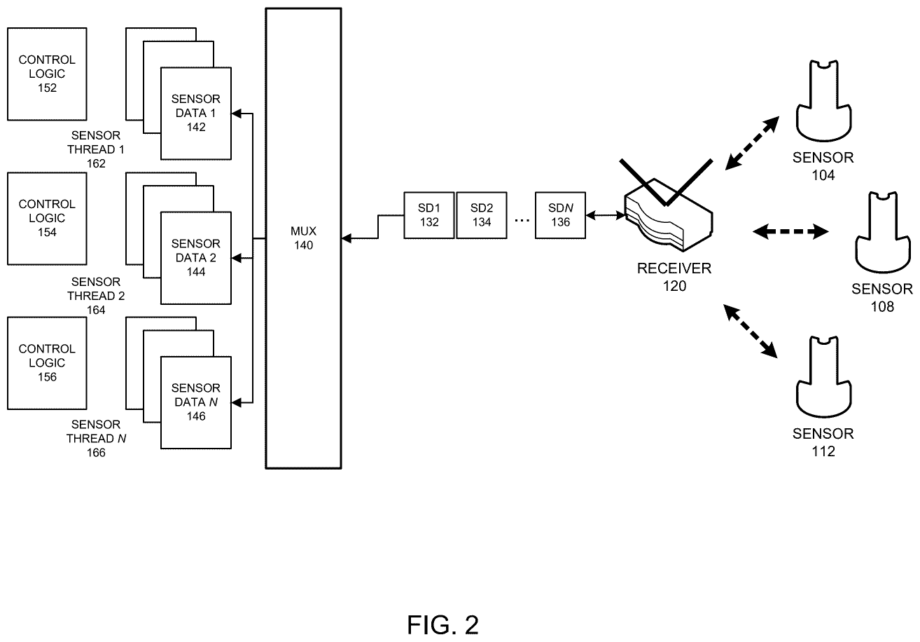

FIG. 2 illustrates an example sensor data multiplexing operation according to example embodiments. Referring to FIG. 2, the receiver 120 is illustrated as communicating with various sensors 104, 108 and 112, however the total number of sensors communicating with the receiver 120 may vary. As sensor data is received, the receiver may store the sensor data in packet form in memory and queue the sensor data in memory using a common queueing technique such as first in first out (FIFO). The sensor data 132, 134, 136 may be multiplexed 140 by the receiver 120 or an intermediate device prior to the data being forwarded to the cloud. Each sensor may have its own thread process 162, 164, 166, etc., in the cloud which maintains corresponding sensor data logs 142, 144 and 146 and logic 152, 154 and 156 used to process the sensor data and provide results. Examples of processed sensor data may include identifying that certain sensor data thresholds were exceeded and creating alerts to notify interested parties.

According to one example, a receiver 120 may transmit data in various directions to any sensors and/or receivers which are listening by broadcasting a message to the surrounding area to identify which sensors are available. Any available or active receivers may respond with a message identifying themselves and one or more receiver capabilities, such as identifying an active Internet connection, current operational status, etc. A sensor may also perform a broadcast operation to send RF signals to other sensors and/or receivers. A sensor may also log response messages from any receivers which respond to the broadcast inquiry. The sensors may rely on their stored information to select a receiver to communication with over a period of time. The selection process may rely on a strongest or largest signal rating, such as a RSSI based on the previous communications between the sensor and the receivers. The receiver will then accept or reject the sensor request to communicate. A receiver may identify its own CPU usage and available memory while supporting one or more sensors to determine whether it can manage additional sensors at any given time.

According to example embodiments, there may be more than one receiver in a particular area, such as a home, office, or other environment. The proportion of receivers to sensors may vary, however, for example purposes, the number may be 20 sensors for each receiver. A sensor may include logic necessary to select one receiver over another assuming they are comparable in signal quality and both have Internet access. When receivers are identified as being comparable, the first one that responded to a sensor message broadcast may be selected. For example, the sensor may transmit a connection request and the receiver may acknowledge the request with a response message as a type of acceptance.

In the event of a rejection, certain rejection criteria may include a receiver identifying that it does not have enough computing resources, such as available memory, CPU processor availability, etc. When the sensor cannot connect to any receivers, it will continue to identify available receivers multiple times. When the sensor determines it cannot connect to any receivers, it will save any data it has generated during the communication session inside its flash memory and then it may lapse into a sleep mode. The sensor may schedule a wake-up time for some time in the future. There may be a periodic sampling time used be each sensor, however, a schedule may be used to provide a time for a particular sensor to wake-up in order to provide a way to synchronize with other sensors that may be using the available bandwidth of a receiver. This may include assigning a random time to the regular sleep time for a sensor to awake in the future.

In general, a receiver will not change the current channel being used to communicate with one or more sensors. The channel will be shared by using a multiplexing approach to receiving data from one sensor at a time and forwarding the sensor data to the cloud one instance at a time. A receiver may be able to manage a communication session with more sensors when the communication intervals are longer. In other words, the number of sensors a single receiver can manage at one time is inversely proportional to an amount of time between each sensor sharing operation. If the sensor data is shared by sensors multiple times in a single minute, the number of sensors a single receiver can manage is lower than the number of sensors sharing data once every 10 minutes. Additionally, if a data congestion occurs at a receiver, the newer sensor data for a particular sensor is more relevant than older sensor data. The more recent data for a particular sensor may be forwarded first and/or the older sensor data may be discarded if multiple rounds of data are queued at a particular receiver. Also, a sensor may queue its own data samples especially when a receiver has not confirmed receipt of such sensor data. In this case, the older sensor data may be discarded when the sensor is able to confirm a receiver is available for data communications with the sensor.

In the cloud network, a cloud application may track a version of a particular receiver to determine whether a mismatch has occurred based on recent sensor data. The current version may be stored in a database to be a number that is above or greater than a configuration site sensor version. The receiver may receive an indication that a new version of software is available for corresponding sensors. This may include a new packet(s) with the new configuration for the sensors, and when the receiver communicates with the sensor again, the new version information may be forwarded to the sensor(s).

In one example, a sensor may be attempting to communicate with more than one receiver at a time. Such a configuration may include using a configuration cache, where a receiver will store sensor information about a particular sensor for a period of time (e.g., 24 hours). Any time sensor configuration data is received by the receiver, the sensor data may be retrieved and will be updated to ensure those known sensors are still being monitored. The cloud application may also maintain records of receivers with particular sensor relationships, so that when a configuration package or other software change is identified, the necessary data will be shared with those receivers that have had recent communications to increase the likelihood that relevant sensors will be included with the configuration changes. When there are multiple sensors and multiple such an approach will ensure that the sensors receive the new data.

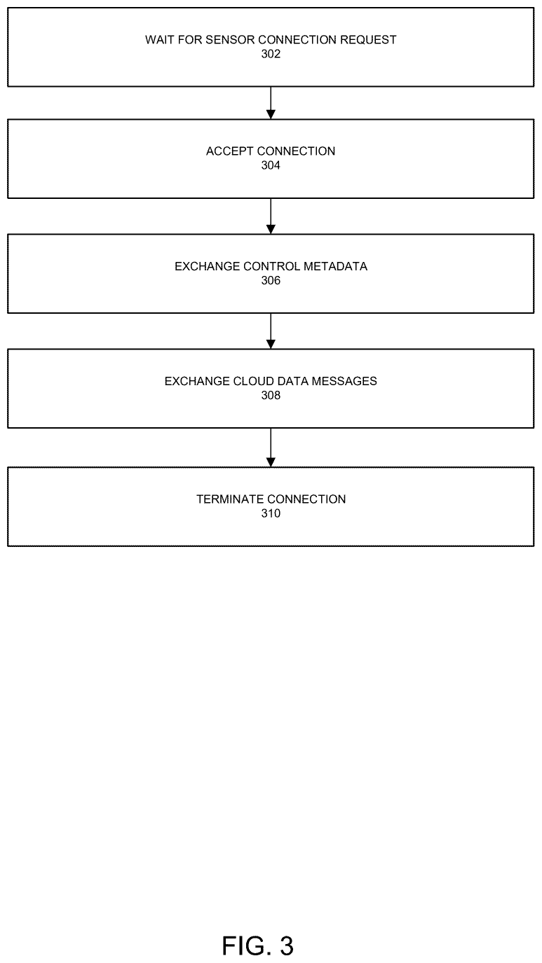

FIG. 3 illustrates an example process of a receiver establishing a connection with one or more sensors according to example embodiments. Referring to FIG. 3, the operation of the receiver when identifying an available sensor may include waiting for a sensor connection request 302, such as one or more sensors that are transmitting requests to any receivers which are currently in a listening and/or available mode of operation. The process may also include accepting a connection 304 to communicate with the requesting sensor. The decision to accept the connection may be based on whether the receiver has knowledge of available resources, such as memory, CPU capacity, a number of other active sensors communicating with the receiver, an active Internet connection, etc. The sensor and the receiver may exchange certain control information, such as metadata 306 used to maintain communications, such as a channel number, port number, communication frequency, identification values, etc. Once the receiver has received and identified one or more sensor messages, such as current sensor data, the cloud messages may be exchanged with a server in the cloud 308 to maintain a record of the messages for that particular sensor. The connection may be terminated 310 once a time window has matured or after failing to receive any messages from the sensor for a certain amount of time.

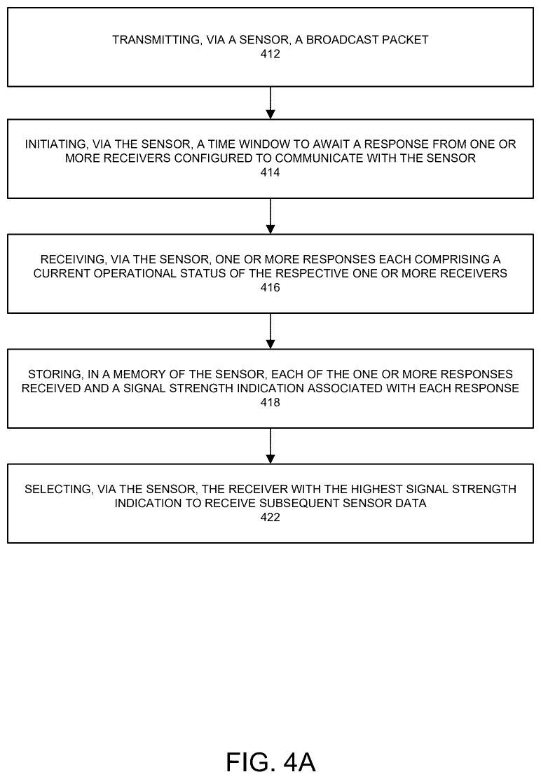

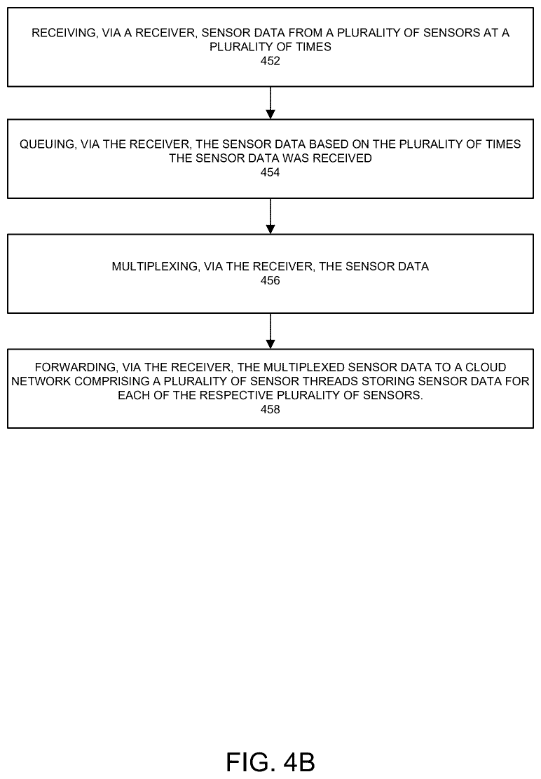

FIG. 4A illustrates an example process of the sensor identifying and selecting available receivers according to example embodiments. Referring to FIG. 4A, the process may include transmitting, via a sensor, a broadcast packet 412, initiating, via the sensor, a time window to await a response from one or more receivers configured to communicate with the sensor 414. The time may be maintained by the sensor in an internal control unit that is initiated once the broadcast message is sent. The process may also include receiving, via the sensor, one or more responses each including a current operational status of the respective one or more receivers 416, storing, in a memory of the sensor, each of the one or more responses received and a signal strength indication associated with each response 418, selecting, via the sensor, the receiver with the highest signal strength indication to receive subsequent sensor data 422. The sensor may store various RSSI values in memory and select the one that is the strongest or largest to be the receiver that is used for communication with the sensor. The strongest signal indicates that less power is needed to maintain communications between the sensor and the receiver.

FIG. 4B illustrates an example process of the receiver managing sensor data according to example embodiments. Referring to FIG. 4B, the process may include receiving, via a receiver, sensor data from a plurality of sensors at a plurality of times 452. The receiver may be configured to communicate with a number of different sensors to receive sensor data and to maintain a communication channel with each of the sensors for subsequent sensor data. The receiver may not forward the sensor data to the cloud immediately and may queue the sensor data based on the plurality of times the sensor data was received 454, such as in an ordered format based on time or priority of the sensors. The receiver may perform multiplexing of the sensor data 456 from each of the sensors into a packetized data format. The process may also include forwarding, via the receiver, the multiplexed sensor data to a cloud network including a plurality of sensor threads storing sensor data for each of the respective plurality of sensors 458.

The process may also include receiving, via the receiver, from each of the plurality of sensors, a broadcast packet, and transmitting, via the receiver, one or more responses to the plurality of sensors. The one or more responses may indicate an operational status of the receiver. Each of the plurality of sensors may initiate a time window to await a response from the receiver after the broadcast packet is sent, and stores in a memory the current operational status and a received signal strength indicator (RSSI) of the receiver. Each of the plurality of sensors may select the receiver to receive subsequent sensor data if the receiver has a highest RSSI among a plurality of RSSI values stored in each of the plurality of sensors. The receiver may include a plurality of radio frequency (RF) channels assigned to a plurality of different frequencies, and wherein the receiver selects one RF channel to use at a particular time. Each of the plurality of sensors may be configured to detect the RF channel currently being used by the receiver. The process may also include receiving, via the receiver, one or more connection requests from each of the plurality of sensors, accepting, via the receiver, the one or more connection requests, and exchanging, via the receiver, one or more control metadata messages with each of the plurality of sensors.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

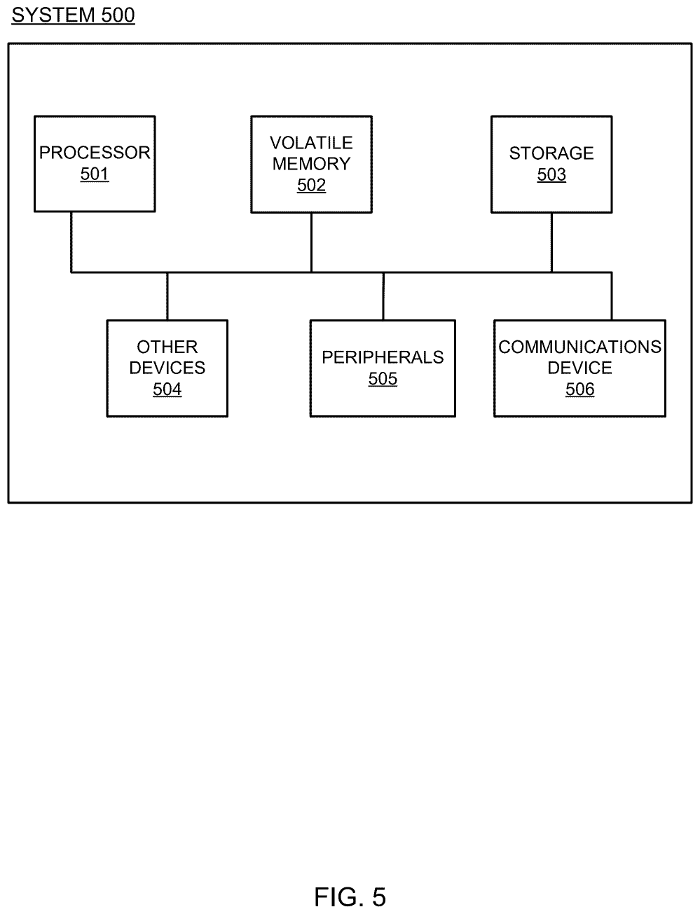

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Peripherals 505 may include removable media devices such as CD-R and DVD-R recorders/players. Communications device 506 may connect the computer 100 to an external medium. For example, communications device 506 may take the form of a network adapter that provides communications to a network. A computer 500 may also include a variety of other devices 504. The various components of the computer 500 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

It should be noted that some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field-programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
receiving, via a receiver, sensor data from a plurality of sensors at a plurality of times;
queuing, via the receiver, the sensor data based on the plurality of times the sensor data was received;
multiplexing, via the receiver, the sensor data; and
forwarding, via the receiver, the multiplexed sensor data to a cloud network comprising a plurality of sensor threads storing sensor data for each of the respective plurality of sensors.

2. The method of claim 1, comprising
receiving, via the receiver, from each of the plurality of sensors, a broadcast packet; and
transmitting, via the receiver, one or more responses to the plurality of sensors.

3. The method of claim 2, wherein the one or more responses indicates an operational status of the receiver.

4. The method of claim 2, wherein each of the plurality of sensors initiates a time window to await a response from the receiver after the broadcast packet is sent, and stores in a memory the current operational status and a received signal strength indicator (RSSI) of the receiver.

5. The method of claim 4, wherein each of the plurality of sensors selects the receiver to receive subsequent sensor data if the receiver has a highest RSSI among a plurality of RSSI values stored in each of the plurality of sensors.

6. The method of claim 1, wherein the receiver comprises a plurality of radio frequency (RF) channels assigned to a plurality of different frequencies, and wherein the receiver selects one RF channel to use at a particular time.

7. The method of claim 6, wherein each of the plurality of sensors is configured to detect the RF channel currently being used by the receiver.

8. The method of claim 1, comprising
receiving, via the receiver, one or more connection requests from each of the plurality of sensors;
accepting, via the receiver, the one or more connection requests; and
exchanging, via the receiver, one or more control metadata messages with each of the plurality of sensors.
